(19) United States
(12) Patent Application Publication
(10) Pub. No.: US 2005/0036144 A1
(43) Pub. Date: Feb. 17, 2005

(54) Position detecting method

(76) Inventor: Takehiko Suzuki, Saitama (JP)

Correspondence Address: MORGAN & FINNEGAN, L.L.P., 3 WORLD FINANCIAL CENTER, NEW YORK, NY, 10281-2101, US

(21) Appl. No.: 10/886,211

(22) Filed: Jul. 7, 2004

(30) Foreign Application Priority Data
Jul. 8, 2003 (JP) 2003-271889(PAT.)

(51) Int. Cl. G01B 11/00

(52) U.S. Cl. 356/401

(57) ABSTRACT

A position detecting method for detecting a position of an object to be detected using a signal from an image of an alignment mark which consists of plural mark elements formed on the object, comprising the steps of acquiring first position information indicating a center position approximated from a form of the all signals, acquiring plural second position information indicating a center position in the alignment mark calculated from whole inflection points of the signal, and selecting the second position information as a center position in the alignment mark which is in a predetermined distance based on the first position from the plural second position information.

This application claims priority benefits based on Japanese Patent Application No. 2003-271889, filed on Jul. 8, 2003, which is hereby incorporated by reference herein in its entirety as if fully set forth herein.

### BACKGROUND OF THE INVENTION

The present invention relates generally to a position detecting method, and more particularly to a position detecting method for detecting a position of objects, such as a wafer, in the exposure apparatus used for manufacturing various devices, such as semiconductor chips as IC and LSI, a liquid crystal display (LCD), CCD, and a magnetic head. This invention is suitable for relative alignment between a reticle and wafer.

The demand for fine semiconductor elements used in an electric device has been greater because an electric devices have become thinner in shape. A conventional projecting exposure apparatus for projecting a circuit pattern of a reticle or a mask onto a wafer etc. by projecting optical system, and for transferring a circuit pattern has been used in a photolithography (printing) for manufacturing a semiconductor element.

A resolution of a projecting exposure apparatus (a minimum size which can be transferred) is proportional to the wavelength of light used for exposure, and inversely proportional to a numerical aperture (NA) of the projecting optical system. Therefore, the wavelength is shortened, and NA is increased, so that the resolution becomes better.

The resolution of the projection exposure apparatus is proportional to a wavelength of light used for exposure, and inversely proportional to the numerical aperture (“NA”) of the projection optical system. Therefore, the resolution becomes better as the wavelength decreases because a smaller resolution is better. Along with recent demands for finer semiconductor devices, a shorter wavelength of ultraviolet light has been promoted from an ultra-high pressure mercury lamp (such as i-line with a wavelength of approximately 365 nm) to KrF excimer laser (with a wavelength of approximately 248 nm), ArF excimer laser (with a wavelength of approximately 193 nm), further, F₂ laser (with a wavelength of approximately 157 nm) and Synchrotron Radiation light.

On the other hand, a projecting exposure apparatus requires not only a finer circuit pattern (namely, improvement in a resolution) but also a higher alignment for aligning a relative position between a reticle and a wafer. An alignment's precision prescription is generally ⅓ or less of a circuit pattern, and, for example, needs overlay accuracy with 60 nm or less when a design rule of the circuit pattern in 1G bit DRAM is 0.18 μm. Here, the overlay means an alignment of whole exposure area. An exposure apparatus has to have a high superposition accuracy above a wafer in order to raise performance of a semiconductor element, and yield (throughput) of manufacture.

Then, it is often a proposed method for bright-field-illuminating the alignment marks AM1 and AM2 formed on a wafer shown in FIGS. 20 and 21, and for signal-performing the alignment signals obtained by scattered light generated by the alignment marks AM1 AM2 shown in FIG. 22. FIGS. 20 and 21 are schematic diagrams indicating an example of the alignment marks AM1 and AM2 on a wafer, FIGS. 20A and 21A are plane views, and FIGS. 20B and 21B are sectional views. FIG. 22 is a schematic waveform view indicating an example of general alignment signal acquired by bright-field-illuminating the alignment marks AM1 and AM2. Moreover, although a resist is applied on the alignment marks AM1 and AM2 in fact, FIGS. 20 and 21 omit them.

The alignment mark AM1 has four mark elements M1_{AM1} to M4_{AM1} which are rectangles which measure 4 μm in a X-direction, which is the scanning direction, and 30 μm in a Y-direction, which is not the scanning direction, and are arranged with 20 μm intervals from the vertical center line of each other in the X-direction. The mark elements M1_{AM1} to M4_{AM1} have a concave shaped cross-sectional structure by etching, as shown in FIG. 20B. On the other hand, an alignment mark AM2 has mark elements M1_{AM2} to M4_{AM2} which replace the line width of the outline portions in the mark elements M1_{AM1} to M4_{AM1} with a line width of 0.6 μm. It is possible to use each of the alignment mark AM1 as shown in FIG. 20 and the alignment mark AM2 as shown in FIG. 21 in order to acquire an alignment signal as shown in FIG. 22. However, regarding to a bright-field image, the mark elements M1_{AM1} to M4_{AM1} in the alignment mark AM1 are dark near the outline, and mark elements M1_{AM2} to M4_{AM2} in the alignment mark AM2 are dark near the concave section.

Signal processing by a bright-field illumination often uses a pattern matching for comparing a correlation rate between a model image as a signal waveform in a criterion mark and the waveform image in the acquired alignment signal, and for detecting a center in an alignment mark (for, example, see Japanese Patent Application Nos. 06-151274 and 11-295056).

Another signal processing is known as a method for detecting an arranging point (generally called an edge) that has a gradation of brightness in the alignment signal change suddenly, and for calculating a center between edges by the edges' distance in order to detect a center in an alignment mark. When an edge is detected, primary differential and secondary differential calculations are performed, and the most sudden changing point in a brightness slope is detected as an edge (the method will be hereafter called the edge differentiation). Therefore, a noise component notably appears in the edge differentiation when a high frequency noise is mixed in an alignment signal. In this case, it is possible to detect a position of the edge corresponding to an alignment mark by a pretreatment for removing a random noise by using a filter etc. without an influence by noise change in a base line of an alignment signal, and by asymmetry of difference between right and left of a signal level (for example, see Japanese Patent Application Nos. 2001-67203 and 10-256350).

However, a signal processing by pattern matching or the edge differentiation often has a large error about a detection result by asymmetry of an alignment signal (Wafer Induced Shift) by a wafer process, and alignment accuracy often deteriorates. In other words, when a noise overlaps with an alignment signal, accuracy of a positional detection gets worse.

The noise has various factors that always includes an optical noise by a detecting method for a wafer process and an alignment mark, and an electric noise. Further, these noises include a random component and a systematic component. For example, a random noise or a systematic noise overlaps with an alignment signal by an influence of a uneven wafer surface or minute asymmetry, etc. of an alignment mark. Since a resist is applied by a spin coat, even if it usually has neither a lumpy wafer surface, nor asymmetry of an alignment mark, nonuniformity of a film thickness occurs near a mark by a level difference of an alignment mark (namely, a concave cross-sectional structure), and causes a systematic noise. Furthermore, a minute defect and contaminant, etc. can cause a random noise.

Conventionally, an error detected as an asymmetrical waveform in the alignment signal from an alignment mark did not become a big practical problem. However, it is necessary to reduce a detection error caused by asymmetry of an alignment signal because a accurate alignment for setting a relative position between a reticle and a wafer has been required.

For signal processing, pattern matching is more accurate (robust) than edge differentiation but edge differentiation is more accurate for positional detection. Edge differentiation has high positional detection accuracy, and often receives an influence of a noise. A position detecting method cannot synthetically perform fine positional detection about an asymmetry (WIS) of an alignment signal. Here, the robustness (tenaciousness) means few changing amounts of a positional detection when a noise overlaps with an alignment signal.

### BRIEF SUMMARY OF THE INVENTION

Accordingly, it is an exemplary object of the present invention to provide a position detecting method that reduces an error in asymmetry of an alignment signal from an alignment mark, and accurately detects a position.

A position detecting method of one aspect embodiment according to the present invention for detecting a position of an object is to be detected using a signal of image in an alignment mark which consists of plural mark elements formed on the object, comprising the steps of acquiring first position information indicating a center position in the alignment mark approximated from all signals, acquiring plural second position information indicating a center position in the alignment mark calculated from all inflection points of the signals, and selecting the second position information as a center position in the alignment mark which is in a predetermined position based on the first position information from the plural second position information.

Other objects and further features of the present invention will become readily apparent from the following description of the preferred embodiments with reference to accompanying drawings.

### BRIEF DESCRIPTION OF THE DRAWINGS

FIG. 1 is a flowchart for explaining a position detecting method of one aspect embodiment according to the present invention.

FIG. 2 is a schematic waveform view of an example setting a center as a center in a mark element calculated by return-symmetrical processing method about a window area which detects an edge of an alignment signal.

FIG. 3 is a schematic correlation view showing relative position relation between an alignment mark and an alignment signal.

FIG. 4 is a schematic waveform view showing an alignment signal with which function fitting by polynomial approximation was performed, and the noise was removed.

FIG. 5 is a schematic waveform view showing the case where a peak signal of a primary differential wave which differentiated the wave of an alignment signal has an influence of noise.

FIG. 6 is a schematic waveform view showing the case where the window area which detects an edge of an alignment signal of a primary differential wave.

FIG. 7 is a graph showing an example of an alignment signal.

FIG. 8 is a schematic waveform view showing an example of an area which performs return-symmetrical processing for calculating a center position from a wave of the mark element shown in FIG. 7(b).

FIG. 9 is a graph which shows a valuation function when an alignment signal is folded and superimposed along a virtual center.

FIG. 10 is a schematic waveform view for explaining change of a positioning detection by an asymmetry of an alignment signal.

FIG. 11 is a schematic waveform view for explaining a position detecting accuracy return-symmetrical processing method and an edge differentiation when a noise is overlapped on an alignment signal.

FIG. 12 is a schematic waveform view for showing an influence of noise, at the time of processing of an alignment signal, caused by an edge differentiation.

FIG. 13 is a schematic waveform view for showing the effect of filters, at the time of processing of an alignment signal, which reduced a noise caused by an edge differentiation in the alignment signal shown in FIG. 12.

FIG. 14 is a schematic waveform view for explaining an effect which an asymmetry of an alignment signal has on a positional detection accuracy of a return-symmetrical processing method and an edge differentiation.

FIG. 15 is a schematic structure view of one aspect embodiment according to the present invention.

FIG. 16 is a schematic structure view of the alignment optical system shown in FIG. 15.

FIG. 17 is a schematic block view showing a main functional module in the processing section shown in FIG. 15.

FIG. 18 is a flowchart for explaining how to fabricate devices (such as semiconductor chips used for ICs and LCDs, and the like).

FIG. 19 is a detailed flowchart of a wafer process as shown in Step 4 of FIG. 18.

FIG. 20 is a schematic view showing an example of an alignment mark on a wafer.

FIG. 21 is a schematic view showing an example of an alignment mark on a wafer.

FIG. 22 is a schematic waveform view showing an example of a-general alignment signal acquired by bright-field-illuminating the alignment mark shown in FIGS. 20 and 21.

### DETAILED DESCRIPTION OF THE PREFERRED EMBODIMENTS

With reference to accompanying drawings, a description will now be given of a position detecting method of one embodiment according to the present invention. In each figure, the same element is designated by the same reference numeral, and a description thereof will be omitted.

A detail description will now be given of a return-symmetrical processing method. A return-symmetrical processing method is a kind of signal processing of pattern matching which determines a good position of coincidence by returning a waveform of an alignment signal.

The return-symmetrical processing method may clearly indicate a position, and finely detect a position when maintaining symmetric property about a center of a pattern (namely, an alignment mark) even if a waveform of the alignment mark changes. When a waveform of an alignment signal asymmetrically changes, a positional detection often has an error because a detected value of an extremal value in a center of a pattern becomes close to surrounding values, and the error often occurs. Therefore, even if a process changes, the return-symmetrical processing method has low changing amount about positional detection in a random noise unless a waveform symmetric property in an alignment signal collapses.

A conventional return-symmetrical processing method calculates coincidence of the alignment signal of right and left waveform from predetermined positions, and defines the position with maximum of the coincidence as a center position of the alignment mark. The coincidence is calculated based on difference between right and left waveform of the returned alignment signal.

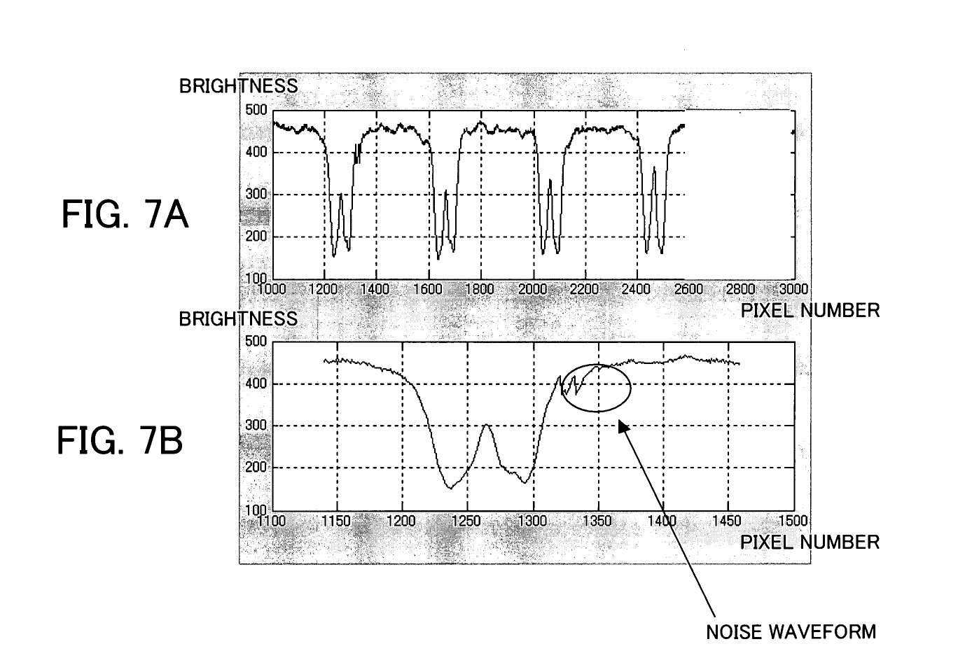

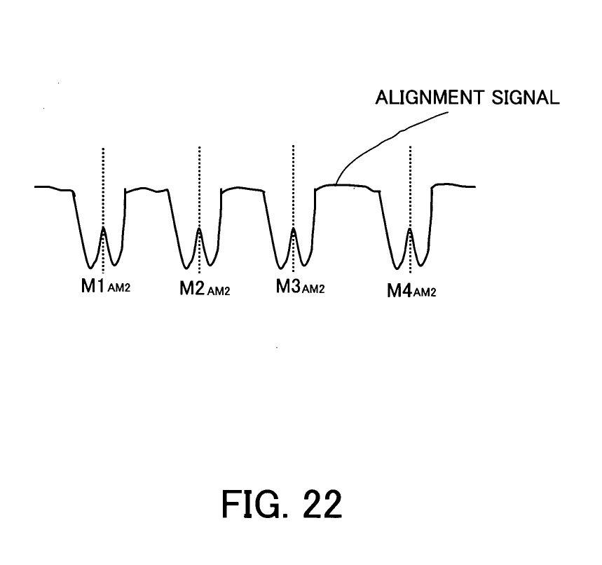

FIG. 7 is a graph which shows an example of an alignment signal. This figure adopts a pixel number as a horizontal axis, and brightness as a vertical axis. FIG. 7A is the same waveform as the alignment signal (namely, an alignment signal acquired by illuminating the alignment mark AM2 of FIG. 21) shown in FIG. 22, and FIG. 7B acquires a waveform detected from one mark element of four rectangle mark elements M1_{AM2} to M4_{AM2} in the alignment mark AM2 shown in FIG. 21.

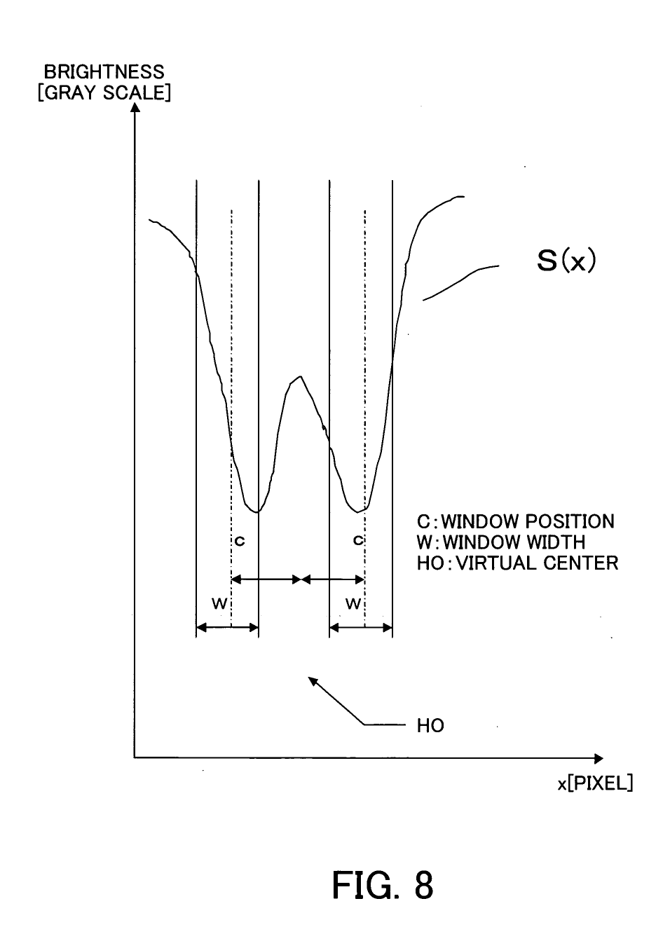

With reference to FIG. 8, a description will now be given of an area (processing range) for performing return-symmetrical processing to calculate a center position from a waveform in an alignment signal. FIG. 8 is a schematic waveform view showing an example of an area for performing return-symmetrical processing to calculate a center position from a waveform of the mark element M1_{AM2} shown in FIG. 7B. An area for superposing a waveform by returning the alignment signal is shown by a window width W from a window position C set as a position distance from a virtual center HO. Coincidence is estimated by comparing the area shown by the window width W from the window position C. Evaluation of coincidence is concretely calculable with the following Equations 1 or 2 as coincidence R (x) in a position x of an alignment signal.

$$\begin{matrix}R ( x ) = {\sum }_{k = c - \frac{w}{2}}^{c + \frac{w}{2}} \frac{1}{{( s ( x + k ) - s ( x - k ) )}^{2}} & ( 1 ) \\ R ( x ) = {\sum }_{k = c - \frac{w}{2}}^{c + \frac{w}{2}} \frac{1}{\vert ( s ( x + k ) - s ( x - k ) ) \vert} & ( 2 )\end{matrix}$$

The coincidence R(x) is a function of the position x of the alignment signal, and since it can be considered as a function evaluating symmetrical properties, it can also be called as a valuation function. Difference in the valuation function shown with Equations 1 and 2 is within a small numerical range, and may use either.

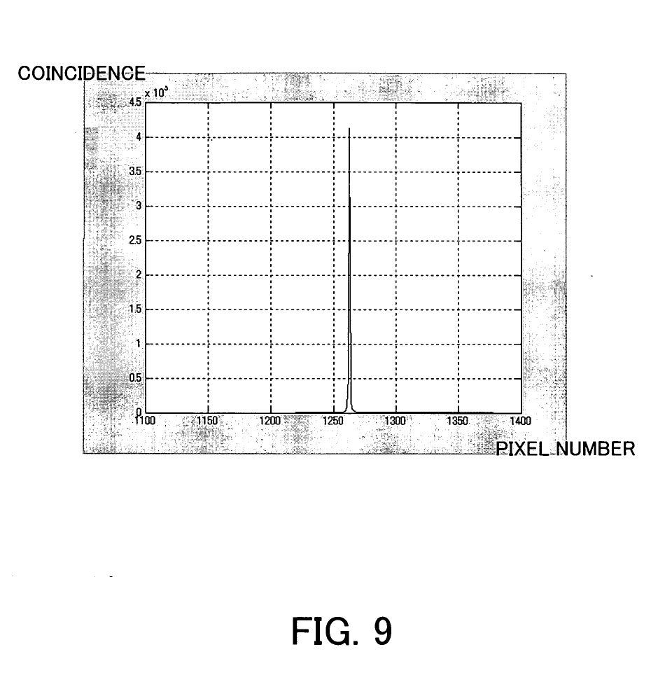

FIG. 9 is a graph which shows the valuation function at the time of returning an alignment signal at a virtual center. This figure calculates the valuation function in the alignment waveform shown in FIG. 7B by the Equation 1, and uses a pixel number as a horizontal axis and coincidence as a vertical axis. A position where a valuation function is maximum is best returning position, and shows the best pixel position in a symmetric property. The position where a valuation function is maximum may be calculated by performing calculation of barycenter and secondary function approximation, etc. in coincidence of each position x and is less accurate than resolution of a sensor.

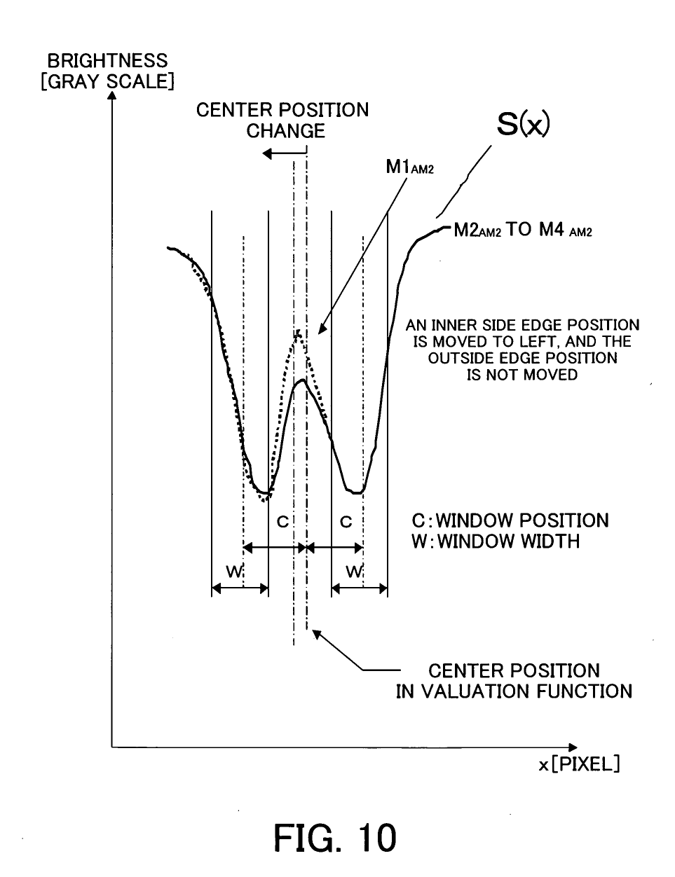

Next, a description will now be given of change of a detecting position about the asymmetry waveform in an alignment signal, and a feature of an edge differentiation. The inventor analyzed an actual alignment signal in a changing process, and discovered existence of a waveform in an alignment signal as shown in FIG. 10. FIG. 10 is a schematic waveform view for explaining change of the detecting position by waveform asymmetry in an alignment signal. This figure is that four waveforms from the mark elements M1_{AM2} to M4_{AM2} in the alignment mark AM2 shown in FIG. 21 are superposed.

With reference to FIG. 10, this alignment signal moves several pixels' center positions to left side when performing a return symmetrical processing method. When waveforms of four mark elements M1_{AM2} to M4_{AM2} are compared, an edge portion at inside of the mark element M1_{AM2} has a waveform moved to left side. When compared with the result of superposition inspection, several pixels positions are moved to left side in positional detection coordinates. Since the edge portion at outside of the mark elements M1_{AM2} to M4_{AM2}'s waveforms have good superposition, there is no changing amount of positional detection when the edge portion at the outside the mark elements M1_{AM2} to M4_{AM2} is detected, and edge differentiation which calculates a center position from an average between these edges is used.

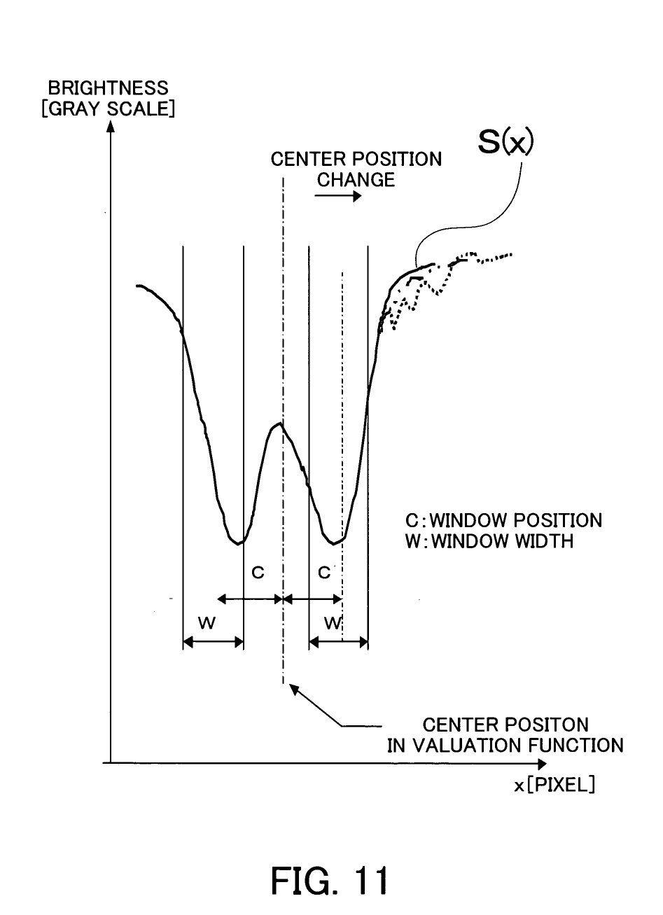

FIG. 11 is a schematic waveform view for explaining influence of positional detection accuracy in a return-symmetrical processing method and an edge differentiation when a noise is superposed on an alignment signal. The noise is produced in an upper right portion of the alignment signal. The return-symmetrical processing method increases a waveform length towards the right side assuming that there is no noise, and a detected center position is changed dependent upon the noise present in the alignment signal.

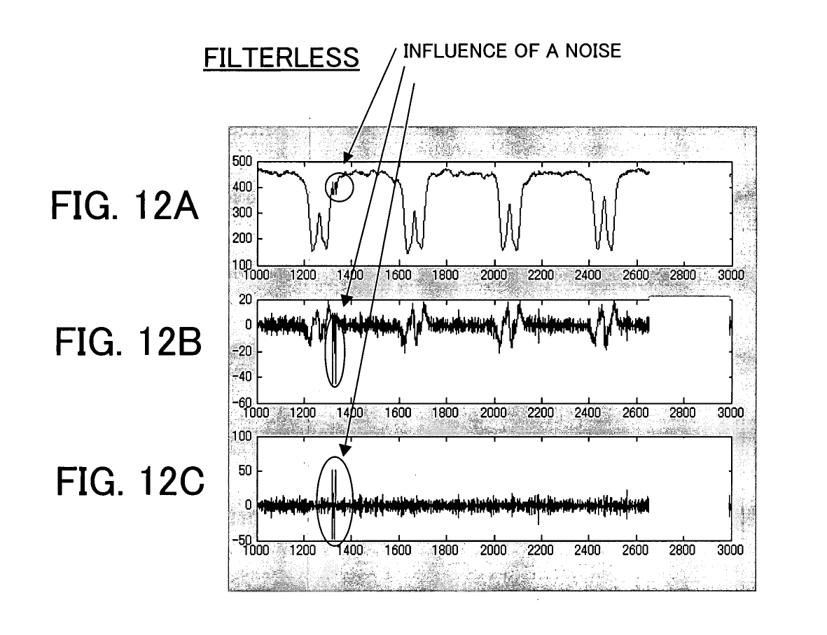

On the other hand, an edge differentiation can have a low influence of the noise because maximum of a peak signal is lower than a slope of the edge portion when it differentiates, and a slope of the noise portion is gentler than that of the edge portion. FIG. 12 is a schematic waveform view for explaining an influence of noise at-the time of processing the alignment signal caused by the edge differentiation. This figure indicates the influence of noise on the primary differential and secondary differential calculations which causes a steeper slope in the edge portion of the alignment signal.

FIG. 12A is an original waveform in the alignment signal, FIG. 12B is a primary differential waveform that differentiated the waveform in the alignment signal of FIG. 12A, and FIG. 12C is a secondary differential waveform that further differentiated the primary differential waveform of FIG. 12B. With reference to FIG. 12, influence of noise occurs in a primary differential waveform and a secondary differential waveform when the edge portion of the alignment signal has a steeper slope.

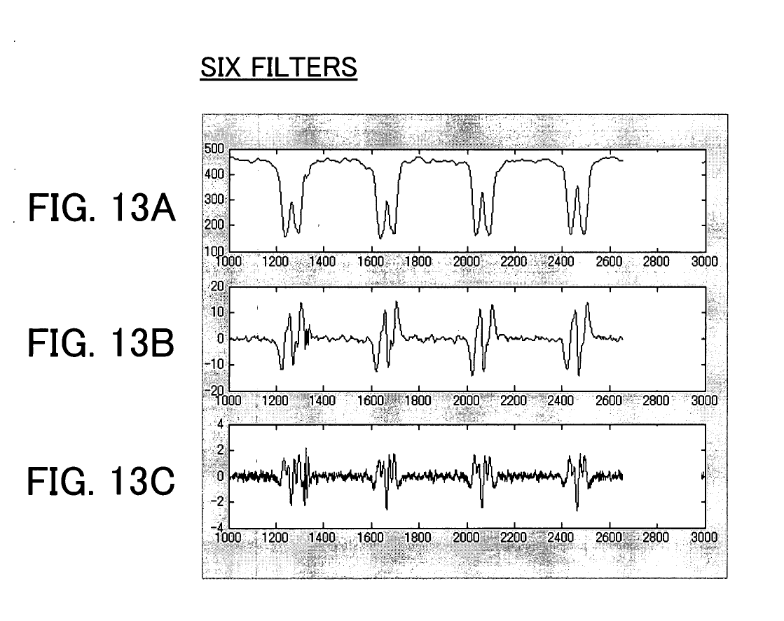

FIG. 13 is a schematic waveform view for explaining influence of a filter at the time of processing the alignment signal that reduced the noise in the alignment signal shown in FIG. 12 caused by an edge differentiation. This figure shows an example which reduces a noise by applying 0 phase filter (filter that does not generate a phase shift) which reduces a phase shift to the alignment signal where the noise is present. FIG. 13A is a waveform at the time of applying 6^{th} zero phase filter to the alignment signal shown in FIG. 12A, FIG. 13B is a primary differential waveform which differentiated a waveform by the alignment signal shown in FIG. 13A, and FIG. 13C is a secondary differential waveform which further differentiated the primary differential waveform shown in FIG. 13B. With reference to FIG. 13, noise generating is suppressed by a filter effect. However, since the whole alignment signal is distorted, increasing the degree of a filter will also make distortion occur in the edge (a maximum inclining point or inflection point of brightness). Therefore, there is a problem that a high order filter cannot be applied because positional detection changes only on a part of distortion. Using the following function fitting solves this problem.

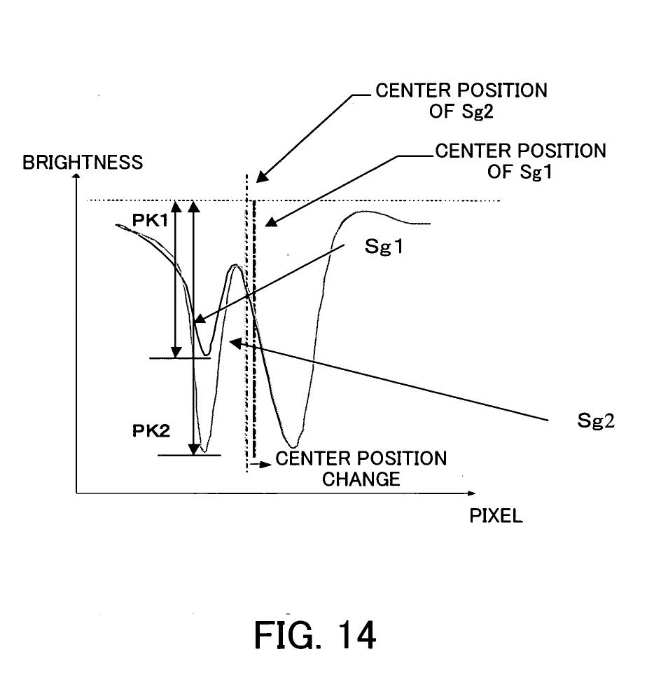

Next, there is an example that although change of positional detection arises in a return-symmetrical processing method, the change of positional detection does not arise in an edge differentiation. FIG. 14 is a schematic waveform view for explaining influence of asymmetrical alignment signal on accuracy of a return-symmetrical processing method and an edge differentiation positional detection. This figure shows an example of asymmetry in a waveform level of right and left in an alignment signal.

With reference to FIG. 14, the peak signal pk2 of the alignment signal Sg2 is larger than the peak signal pk1 of the peak signal Sg1. Therefore, when the alignment signals Sg1 and Sg2 are processed using a return-symmetrical processing method, valuation function of Equation 1 or Equation 2 shows changing center position of waveform in the alignment signal Sg2 to right side. Change of a center position can be suppressed by the edge differentiation so that an outside edge may be detected in the alignment signal Sg2 of the asymmetrical waveform.

By the above things, this inventor composites different signal processing methods, and proposes a position detecting method having employed the feature of each signal processing efficiently.

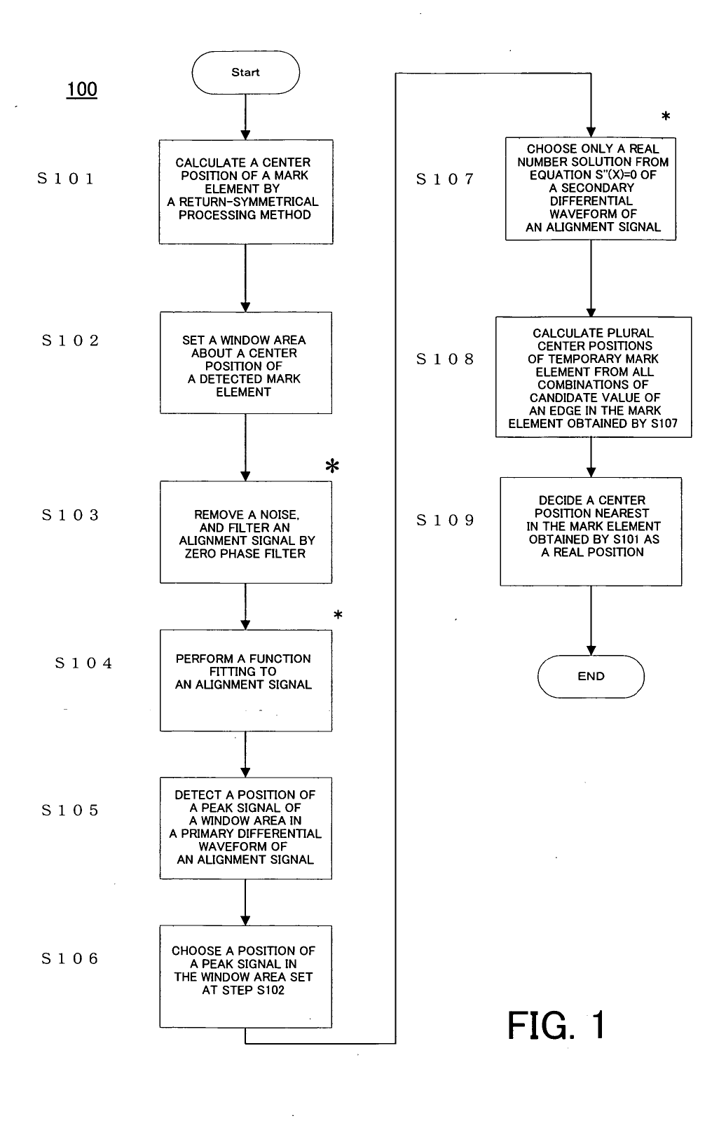

FIG. 1 is a flowchart for explaining one aspect of a position detecting method 100 according to the present invention. The position detecting method 100 of the present invention calculates a center position of a mark element which constitutes an alignment mark, and detects a center position of whole alignment mark by averaging the center position of each mark element. FIG. 1 shows steps calculating a center position of the mark element which constitutes an alignment mark.

With reference to FIG. 1, a center position of one mark element which constitutes an alignment mark by a return-symmetrical method is calculated (step S101). Because it is for calculating the average center position of the whole mark element by the return-symmetrical processing method. Next, a window area which detects an edge (namely, point of inflection) by the edge differentiation is set up in a center as the center position of the calculated mark element (step S102). A window position and window width of the window area may be distributed to the center position acquired by the return-symmetrical processing method, and be set two or more window areas divided into plurality.

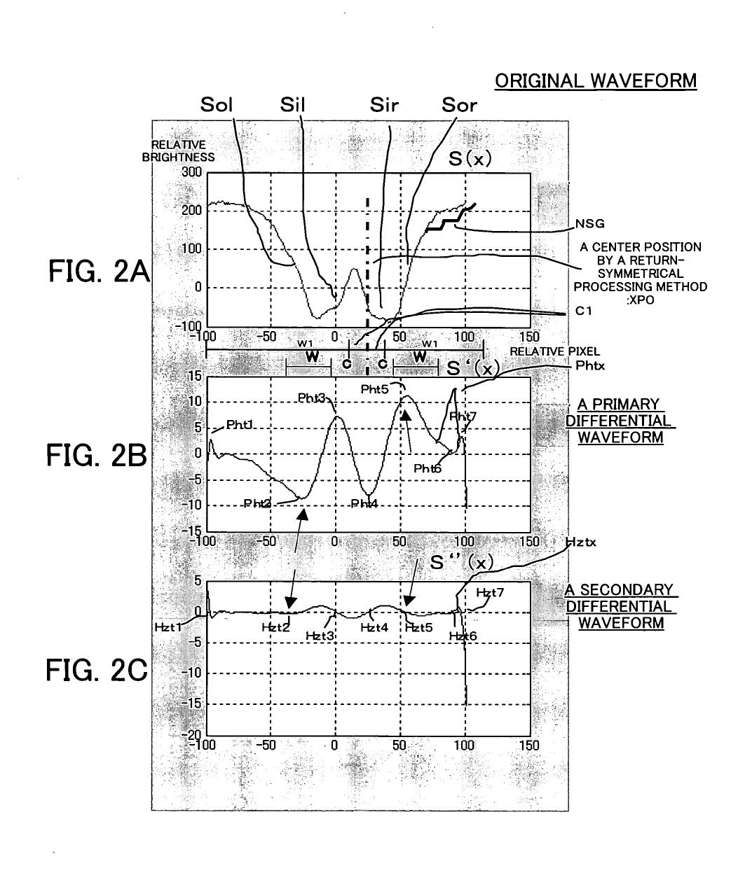

FIG. 2 is a schematic waveform view showing an example at-the time of setting the window area detecting an edge of an alignment signal as the center position of the mark element calculated by the return-symmetrical processing method. This figure adopts a relative pixel as a horizontal axis, and relative brightness as a vertical axis. FIG. 2A is a waveform of an alignment signal from a mark element, FIG. 2B is a primary differential waveform which differentiated a waveform of FIG. 2A, and FIG. 2C is a secondary differential waveform which further differentiated the primary differential waveform of FIG. 2B. The waveform of FIG. 2A is expressed as function S(x), the waveform of FIG. 2B is expressed as function S′(x) and the waveform of FIG. 2C is expressed as function S″(x). The window positions C and C1 and the window width W may be portioned out and set up to the center position Xpo acquired by the return-symmetrical processing method, and may widen window width W as a window position C=0. In the figure, the window width W shows the case of limiting a window area to some extent when the window width W1 sets a large window area. It is possible to be the same as the window area of the return-symmetrical processing method. With reference to the secondary differential waveform in FIG. 2C which differentiated the alignment signal shown in FIG. 2B, a peak signal occurs in the point of inflection in an alignment signal.

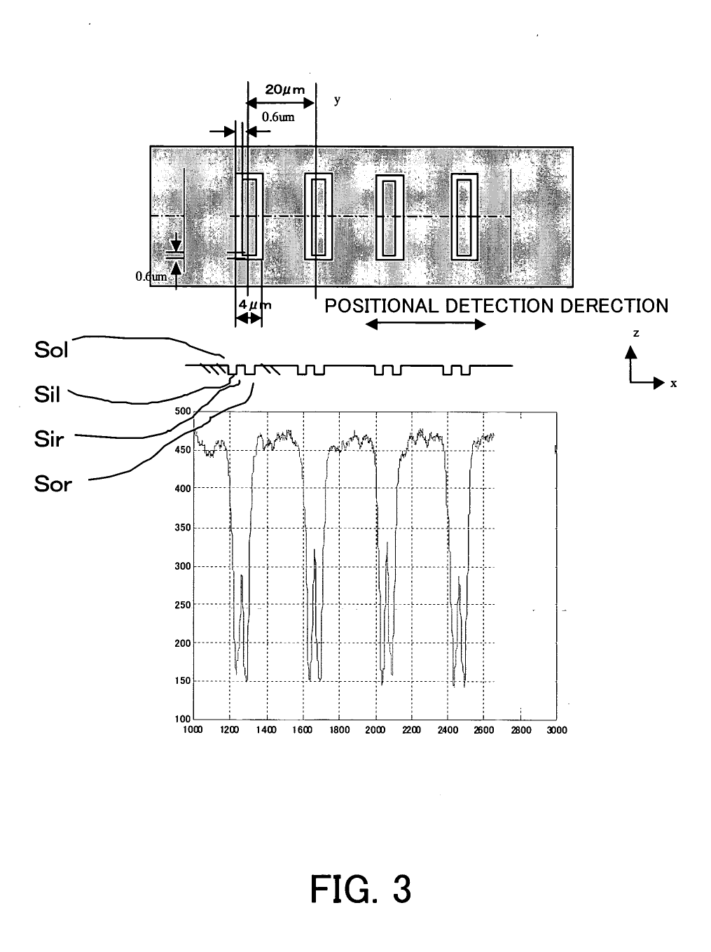

A description will now be given of relation between the position in a peak signal and an original waveform of an alignment signal. The waveform of the alignment signal shown in FIG. 2A has four slopes which show brightness change. These four slopes are shown in figure as Sol, Sil, Sir and Sor. Suffixes “o”, “i”, “l” and “r” respectively mean an outside edge, an inner side edge, left side and right side. FIG. 3 is a schematic correlation view showing a relative position relation between an alignment mark and an alignment signal. This figure is the same also about the remaining mark elements, although only the right side mark element shows a relation between a level difference of a mark element and the slopes Sol, Sil, Sir and Sor.

FIG. 3 discloses that brightness slope of an alignment signal occurs with correspondence to the level difference of a mark element. This shows that these are correlated with a position of the peak signal of a primary differential waveform. In other words, the position of the peak signal of the primary differential waveform shows the point of inflection of the slope of an alignment signal. The conventional edge differentiation defines an edge by this point of inflection and a zero cross point of a secondary differential waveform described later. When many points of inflection exist by distortion of an alignment signal, two or more peaks often occur in a peak. FIG. 2B shows the peak of a primary differential waveform by using pht1 to pht7 and phtx. The peak phtx shows an occurring noise when a noise NSG shown in FIG. 2A mixes with an original waveform of an alignment signal. With reference to FIG. 2C, a position of a peaks pht1 to pht7 and phtx in a primary differential waveform correspond to Hzt1 to Hzt7 and Hztx which are expressed as a solution of an equation as S″(x)=0 in a secondary differential waveform. Since being a discrete value for every pixel, the waveform of an actual alignment signal needs processing of function approximation. It is desirable to change an approximation method and a function approximate to an area which performs function approximation about function approximation. When polynomial approximation is performed, function approximation can be also performed in a waveform of a complicated alignment signal.

In FIG. 1, an alignment signal is filtered with a zero phase filter in order to remove a noise (step S103). Filtering uses small degree as the secondary because a waveform deformation of an alignment signal becomes large by multiplying filter degree. An alignment signal often includes a waveform with few noises, and an alignment signal with few noises is unnecessary to be filtered.

Next, function fitting is performed on the waveform of an alignment signal (step S104). It is possible to detect an edge by sub-pixel (pixel below decimal point) by performing the function fitting to the waveform of an alignment signal and a discrete value of a pixel. A function approximates in a polynomial. Although this embodiment of the operation uses not only the example of polynomial approximation but also nonlinear functions, such as a GAUSS function.

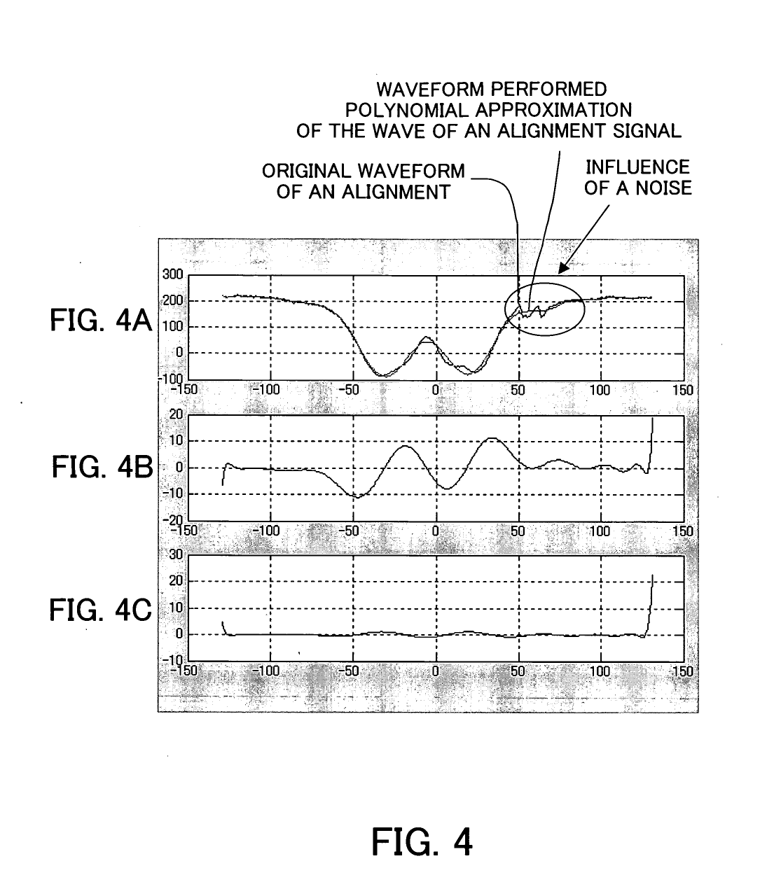

FIG. 4 is a schematic waveform view showing the alignment signal which performed function fitting by polynomial approximation and removed the noise. FIG. 4A shows an original waveform of an alignment signal, and a waveform which performed function fitting by polynomial approximation. This embodiment performs function fitting with 16^{th} high order function. FIG. 4B shows a primary differential waveform which differentiated the waveform of an alignment signal which performed function fitting shown in FIG. 4A, and FIG. 4C shows a secondary differential waveform which further differentiated the primary differential waveform shown in FIG. 4B. With reference to FIG. 4, a peak signal as shown in FIG. 12B can be deleted. However, eliminating a factor of a noise in function fitting has problem that it creates a large difference with the original waveform of an alignment signal. Therefore, care has to be taken in performing polynomial approximation. There is spline interpolation which divides a section performing polynomial approximation into two or more sections, and performs polynomial approximation for each of the plural sections in order to perform relatively low order approximation. Since polynomial approximation has a long processing time, it has to chosen based on an evaluation of demanded accuracy and required processing time.

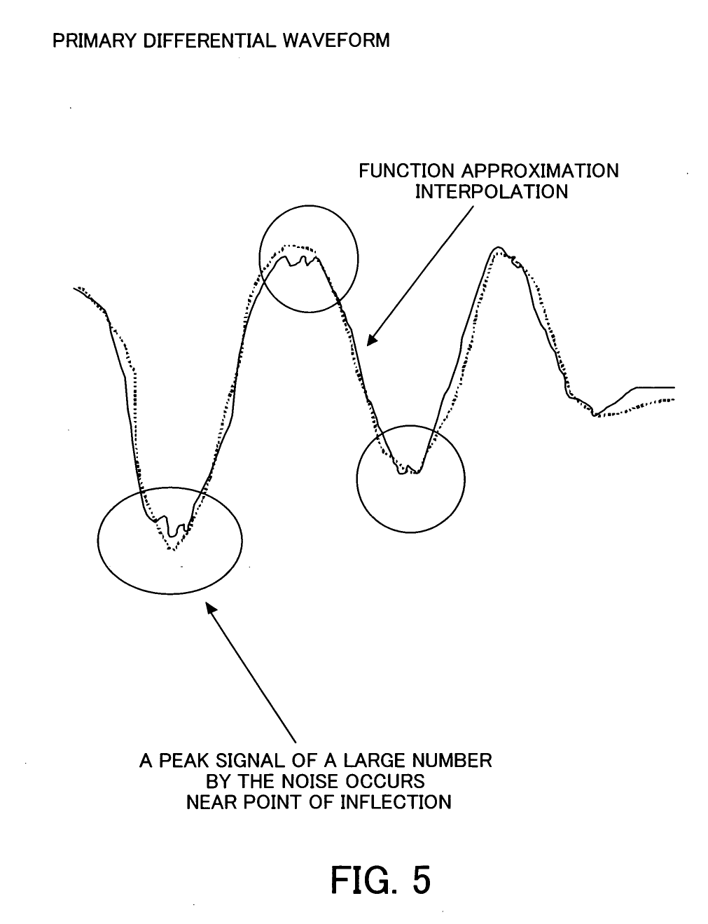

FIG. 5 is a schematic waveform view showing the case where the peak signal of a primary differential waveform which differentiated a waveform of an alignment signal breaks. Since the peak signal of a primary differential waveform has much noise in FIG. 5, it is difficult to distinguish a true peak signal. A component of a noise is removable by earlier performing polynomial approximation of an original waveform of an alignment signal. Approximation degree can be optimized by performing polynomial approximation by plural degree, and by choosing from plural waveforms based on a center position of a mark element detected at the step S101.

With reference to FIG. 1 again, a position of the peak signal in a widow area is detected in the primary differential waveform that once differentiated an alignment signal (step S105), and a position of the peak signal in the window area set up at the step S102 is chosen (step S106). When the window width W1 is set up, the peak pht2, pht4 and pht6 as a candidate of a minimum peak value shown in FIG. 2B, and pht1, pht3, pht5, pht7 and phtx as a candidate of a maximum peak value shown in FIG. 2B are obtained by the window area set up at step S102. The minimum peak value is an edge candidate on left side of a mark element, and the maximum peak value is an edge candidate on right side of a mark element. A numerical solution of a sub-pixel performs the above polynomial approximation, solves an equation of Function S″(x)=0, and chooses only a real number solution (step S107). Peak value is calculated by detecting a numerical range from a number which previously determined a peak value candidate by the peak value of a primary differential waveform, i.e., a minimum value, a second minimum value counted from the minimum value and a third minimum value counted from the minimum value. Those peak values are compared with a real number solution which solved equation of Function S″(x)=0, and the real number near a minimum peak value and a maximum peak value are chosen. This is a candidate value of a position of an edge on left and right side in a mark element.

Step S108 calculates two or more temporary center positions of a mark element from all the combination of the candidate value of the position of the edge on the left and right side of the mark element obtained at the step S107.

A center position is set as a true center position with a smallest difference between plural center positions of the mark element obtained by the step S108 and a center position of the mark element obtained by the return-symmetrical processing method in the step S101 (step S109). A center position may be set by choosing in order of a small difference between center positions of the mark element obtained by the step S101, and equalizing a value in an error range set up predetermined. Thereby, the error by asymmetry of the alignment signal in an alignment mark can be reduced, and position detection can be performed with high accuracy.

In FIG. 1, function fitting by filtering and polynomial approximation was performed as noise removal of an alignment signal at the steps S103, S104 and S107. Polynomial approximation was used in order to detect a position of an edge in sub-pixel accuracy. The noise removal can also be performed because there are few high frequency noises in many cases according to the process. The edge position of a sub-pixel may calculate a part of peak range portion in a primary differential waveform of an alignment signal by a barycenter.

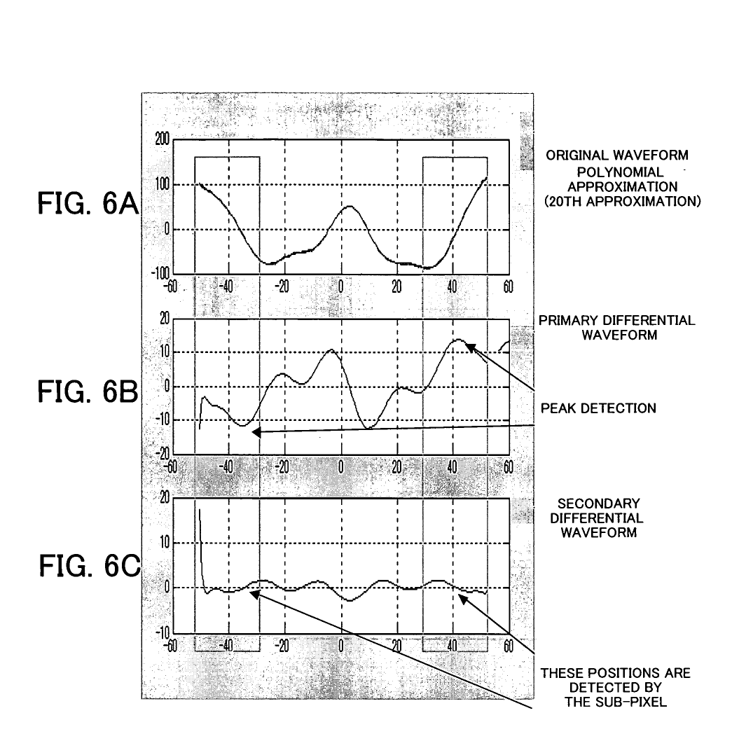

FIG. 6 is a schematic waveform view showing the case where a smaller window area which detects an edge of an alignment signal is chosen in a primary differential waveform. FIG. 6A is a waveform which performed function approximation by a 20^{th} polynomial and an original waveform of an alignment signal, FIG. 6B is a primary differential waveform which differentiated the waveform shown in FIG. 6A, and FIG. 6C is a secondary differential waveform which further differentiated the primary differential waveform shown in FIG. 6B. A maximum peak value and a minimum peak value may be chosen from a difference between the maximum peak value and the minimum peak value that is near a setting range set from the waveform of an alignment signal when it is difficult to narrow the minimum peak value and the maximum peak value from the primary differential waveform. It is possible to further narrow the window area by pre-setting window widths WR and WL, and setting values of a window position C and a window width W which are set from a center position obtained by the return-symmetrical processing method so that a range of the window widths WR and WL may be overlapped.

A position detecting method 100 according to the present invention may use a geometrical pattern matching or template matching as another pattern matching instead of the return-symmetrical processing method.

When using a template chosen appropriately, the template matching may reduce incorrect detection about waveform change of an alignment signal because a comparatively macroscopic feature may be caught and extremal value which shows a center position may be clarified. However, it has to be careful because a sharpness of an extremal value showing a center position has possibility of a decrease depending on a waveform change of an alignment signal, and a changing amount of a center position becomes large.

Geometrical pattern matching is improved template matching, and is very accurate to detect a waveform change of an alignment signal. When geometrical pattern matching is present, it does not influence the position detecting accuracy even if a part of waveform of an alignment signal is not present because it has a similar waveform of the alignment signal.

Referring to FIGS. 15 to 17, a description will now be given of an exposure apparatus 200 according to the present invention. FIG. 15 is a schematic structure of the exposure apparatus 200 of one aspect according to the present invention. The exposure apparatus 200 includes, as shown in FIG. 15, an illumination apparatus 210, a projection optical system 230 that projects diffracted light generated from an illuminated reticle pattern onto the wafer 240, and a wafer stage 250 for supporting the wafer 240 on a predetermined position, an alignment optical system 260 for measuring a position of an alignment mark AM2, a processing means 270 for signal-processing an alignment signal, and a controller 280.

The exposure apparatus 200 is a projection exposure apparatus that exposes onto the wafer 240 a circuit pattern on the reticle 220, for example, in a step-and-repeat or a step-and-scan process. Such an exposure apparatus is suitable for a submicron lithography process, and this embodiment exemplarily describes a step-and-scan exposure apparatus (which is also called “a scanner”). Here, “step-and-scan” is an exposure method for continuously scanning a wafer onto the reticle, for exposing a reticle pattern onto the wafer, and for moving the wafer exposed per one shot to the next exposure area. “Step-and-repeat manner” is an exposure method for exposing the wafer per every exposed package of a wafer, for moving the exposed wafer, and for moving to an exposure area of next shot.

The illumination apparatus 210 illuminates the reticle 220 that forms a circuit pattern to be transferred, and includes a light source unit 212 and an illumination optical system 214.

The light source unit 212 uses as a light source, for example, an ArF excimer laser with a wavelength of approximately 193 nm, and a KrF excimer laser with a wavelength of approximately 248 nm. The type of the light source is not limited to the excimer laser, and can use a F₂ excimer laser and YAG laser with a wavelength of approximately 153 nm. For example, when two solid lasers which operate independently are used, there is no coherence between the solid lasers, and speckles resulting from coherence are reduced considerably. The number of laser units is not limited. An optical system for reducing speckles may move linearly or rotationally. When the light source unit 212 uses a laser, it is desirable to employ a beam shaping optical system that shapes a parallel beam from a laser source to a desired beam shape, and a coherent to incoherent light changing optical system that turns a coherent laser beam into an incoherent laser beam. A light source applicable to the light source unit 212 is not limited to a laser, and may use one or more lamps such as a mercury lamp and a xenon lamp.

The illumination optical system 214 is an optical system that illuminates the reticle 220, and includes a lens, a mirror, an optical integrator, a stop, and the like, arranging, for example, a condenser lens, a fly-eye lens, an aperture stop, a condenser lens, a slit, and an imaging optical system in this order. The illumination optical system 214 can use any light whether it is on-axial or off-axial light. The optical integrator may include a fly-eye lens or an integrator formed by stacking two sets of cylindrical lens array plates (or lenticular lenses), and may be replaced with an optical rod or a diffractive element.

The reticle 220 is made from quartz, for example, and forms a circuit pattern (or an image) to be transferred, and is supported and driven by a reticle stage (not shown). Diffracted light emitted from the reticle 220 passes through the projection optical system 230, and then is projected onto the wafer 240. The reticle 220 and the wafer 240 are located in an optically conjugate relationship. Since the exposure apparatus 200 of this embodiment is a scanner, the reticle 220 and the wafer 240 are scanned at a reduced speed of the projection optical system 230, thus transferring the pattern on the reticle 220 to the wafer 240. If it is a step-and-repeat exposure apparatus (referred to as a “stepper”), the reticle 220 and the wafer 240 remain still for exposure.

The projection optical system 230 projects light that reflects a pattern on the reticle 220 as an object surface onto the wafer 240 as an image surface. The projection optical system 230 can use an optical system which has plural lens elements, an optical system (catadioptric optical system) which has plural lens elements and at least one concave or convex mirror, an optical system which has plural lens elements and diffracted optical element such as at least one of kinoform etc., and an optical system of all mirror types etc. Any necessary correction of the chromatic aberration can use a plurality of lens units made from glass materials having different dispersion values (Abbe values), or can arrange a diffractive optical element such that it disperses in a direction opposite to that of the lens element.

The wafer 240 is an object to be exposed, is formed on the alignment mark AM2 shown in FIG. 21, and applies a photoresist. The alignment mark formed on the wafer 240 may be the alignment mark AM1, and is not limited to the alignment mark AM2.

The wafer stage 250 supports the wafer 240 through a wafer chuck 255. The wafer stage WP may use any structure known in the art, and a detailed description of its structure and operation is omitted. The stage 545 may use, for example, a linear motor to move the wafer 240 in XY directions. The reticle 220 and wafer 240 are, for example, scanned synchronously, and the positions of the wafer stage 250 and a reticle stage (not shown) are monitored, for example, by a laser interferometer and the like, so that both are driven at a constant speed ratio. The wafer stage 250 is installed on a stage stool supported on the floor and the like, for example, via a damper. The reticle stage and the projection optical system 230 are installed on a lens barrel stool (not shown) supported, for example, via a damper to the base frame placed on the floor.

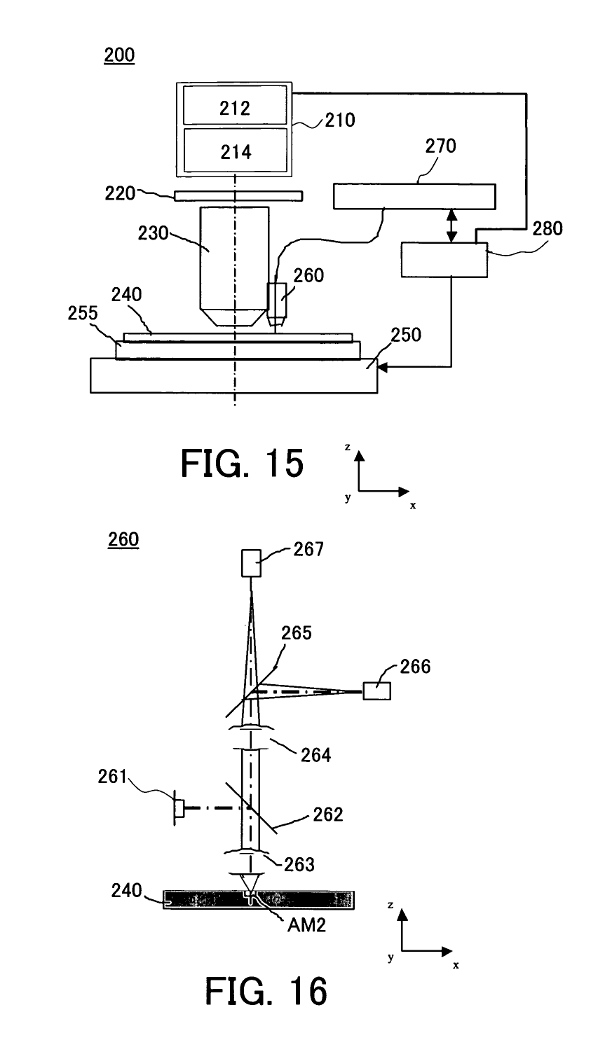

The alignment optical system 260 detects the alignment mark AM2 on the wafer 240, and measures a position of the wafer 240. The alignment optical system 260 includes a light source 261, beam splitters 262 and 265, lenses 263 and 264, and photoelectric conversion elements 266 and 267 as shown in FIG. 16. FIG. 16 is a schematic block view of an alignment optical system 260.

With reference to FIG. 16, illumination light from a light source 261 reflects at a beam splitter 262, and illuminates an alignment mark AM2 onto the wafer 240 through a lens 263. Diffracted light from the alignment mark AM2 passes along the lens 263, the beam splitter 262, and a lens 264, is divided by a beam splitter 265, and is received by the photoelectric conversion elements 266 and 267, such as a CCD sensor. Here, the alignment mark AM2 is expanded by the lenses 263 and 264 for about 100-time image-formation magnification, and is imaged by the photoelectric conversion elements 266 and 267. The photoelectric conversion elements 266 and 267 is for gap measurement of a X-direction of the alignment mark AM2, and for gap measurement of a Y-direction of the alignment mark AM2, and is arranged to rotate 90 degrees about an optical axis.

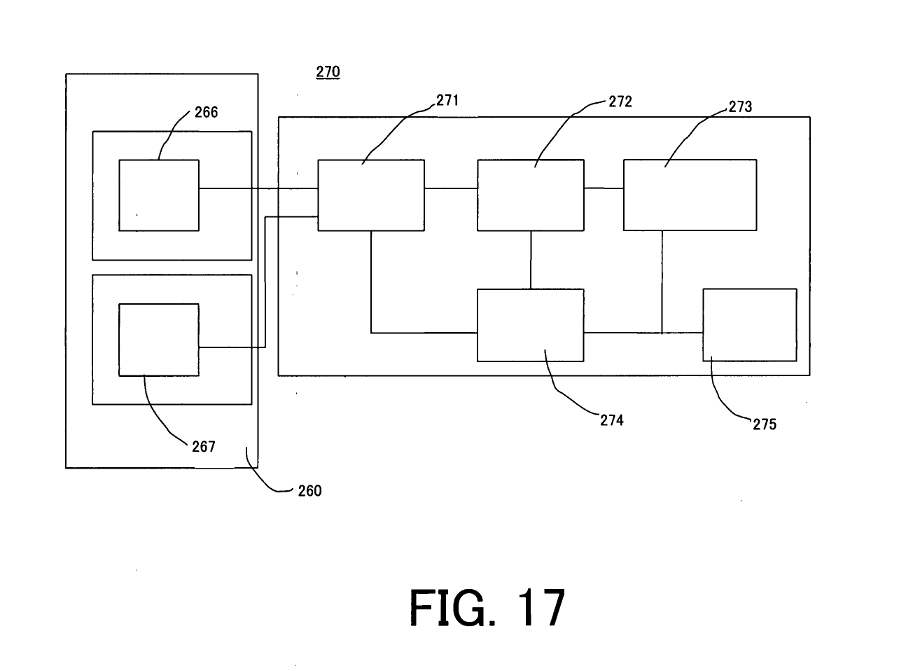

The processing section 270 performs a process for obtaining a position of the alignment mark AM2 in the alignment signal from the alignment optical system 260, i.e., the above position detecting method 100. FIG. 17 is a schematic block view showing a main functional modules stored in the processing section 270 shown in FIG. 15.

With reference to FIG. 17, an alignment signal from the photoelectric conversion elements 266 and 267 is digitized through an A/D converter 271. The digitized alignment signal is removed in a noise component by a various signal-processing circuits (not shown) stored in a recording device 272 and is recorded on a memory. The position detecting element 273 performs signal processing to the recorded and digitized alignment signal. The position detecting element 273 performs the above position detecting method 100, and detects a center position of the alignment mark AM2 by a digitized operation element for an alignment signal. A CPU 274 is connected an A/D converter 271, the recording device 272 and the position detecting element 273, outputs a control signal, controlling an operation. A communication block 275 communicates with the control section 280 shown in FIG. 15, exchanging a required data and control instructions, etc.

The control section 280 includes a CPU (not shown) and a memory, controlling an operation of the exposure apparatus 200. The control section 240 is electrically connected as the illumination apparatus 210, the reticle stage (not shown), the wafer stage 250 and the processing section 270. The control section 280 positions the wafer 240 through the wafer stage 250 based on the center position of the alignment mark AM2. The CPU may include a processor such as a MPU, controlling an operation of each part. The memory consists of a ROM and a RAM, and stores a firmware which operates the exposure apparatus 200.

In exposure, light emitted from the light source unit 212, e.g., Koehler-illuminates the reticle 220 via the illumination optical system 214. Light that passes through the reticle 220 and reflects the reticle pattern is imaged onto the wafer 240 by the projection optical system 230. The exposure apparatus 200 can provide high-quality devices (such as semiconductor devices, LCD devices, photographing devices (such as CCDs, etc.), thin film magnetic heads, and the like) by the position detecting method 100.

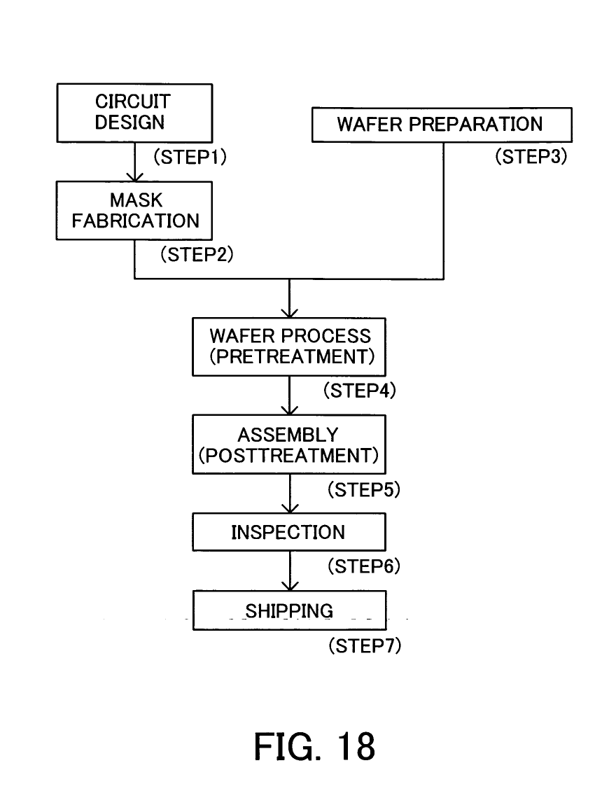

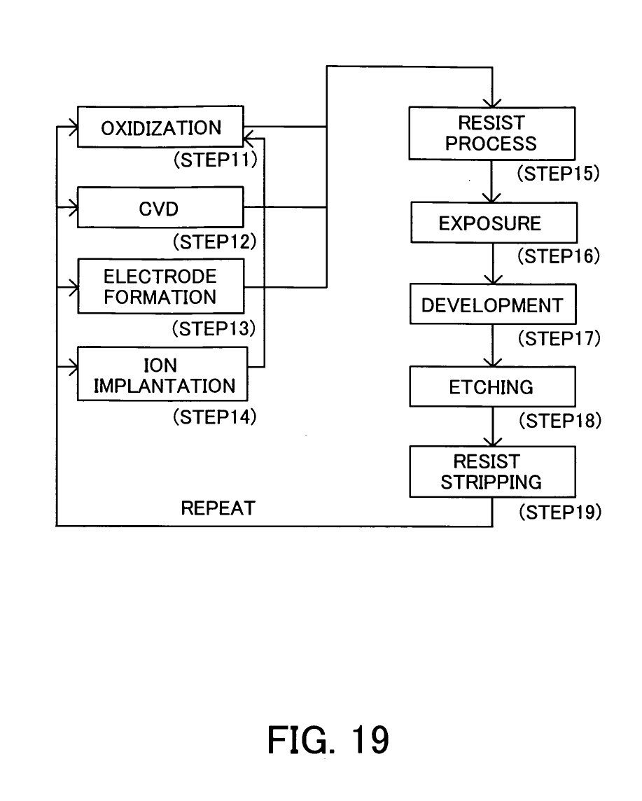

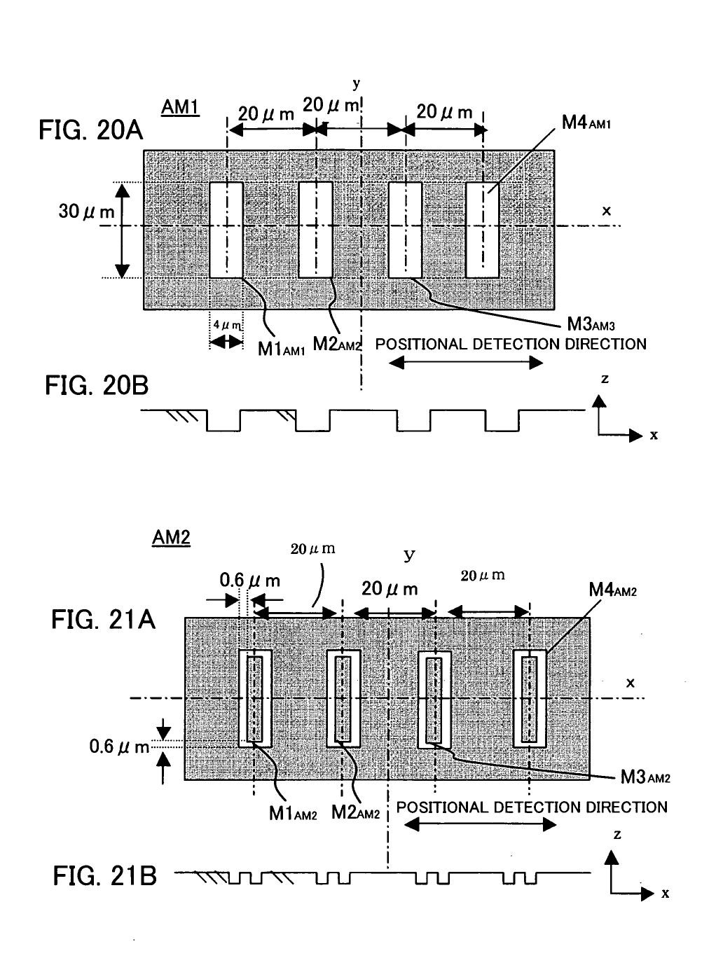

Referring now to FIGS. 18 and 19, a description will be given of an embodiment of a device fabrication method using the above exposure apparatus 200. FIG. 18 is a flowchart for explaining a fabrication of devices (i.e., semiconductor chips such as IC and LSI, LCDs, CCDs, etc.). A description will now be given of a fabrication of a semiconductor chip, as an example. Step 1 (circuit design) designs a semiconductor device circuit. Step 2 (mask fabrication) forms a mask having a designed circuit pattern. Step 3 (wafer preparation) manufactures a wafer using materials such as silicon. Step 4 (wafer process), which is referred to as a pretreatment, forms actual circuitry on the wafer through photolithography using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 19 is a detailed flowchart of the wafer process in Step 4 in FIG. 16. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (exposure) applies the photosensitive material described in the above embodiments onto the wafer, and uses the exposure apparatus 200 to expose a circuit pattern on the mask onto the wafer. Step 16 (development) develops the exposed wafer. Step 17 (etching) etches parts other than a developed resist image. Step 18 (resist stripping) removes the disused resist after etching. These steps are repeated, and multilayer circuit patterns are formed on the wafer. This fabrication method can manufacture higher quality devices than the conventional ones. Thus, the device fabrication method that uses the exposure apparatus 200 and the device as resultant products constitute one aspect according to the present invention.

Further, the present invention is not limited to these preferred embodiments, but various modifications and variations may be made without departing from the spirit and scope of the present invention.

Thus, the present invention can provide the position detecting method for reducing an error by asymmetry of the alignment signal from an alignment mark, and for accurately detecting a position.

1. A position detecting method for detecting a position of an object detected by using a signal of image in an alignment mark which consists of plural mark elements formed on the object, comprising the steps of:
acquiring first position information indicating a center position in the alignment mark approximated from a form of all the signals;
acquiring plural second position information indicating a center position in the alignment mark calculated from all inflection points of the signal; and
selecting the second position information as a center position in the alignment mark which is in a predetermined position based on the first position information from the plural second position information.

2. A position detecting method for detecting a position of an object detected by using a signal of an image in an alignment mark which consists of plural mark elements formed on the object, comprising the steps of:
acquiring position information indicating a center position in the alignment mark approximated from a form of the whole signals;
detecting an inflection point of the signal which is in a predetermined distance based on the position information; and
calculating the center position in the alignment mark from the inflection point detected by the detecting step.

3. A position detecting method according to claim 1, wherein the second position information acquiring step includes the steps of:
reducing a noise contained in the signal;
calculating a peak signal from primary differential signals obtained by differentiating the signal and reducing the noise by the noise deducing step;
calculating a solution of secondary differential signals by further differentiating the primary differential signals; and
selecting a solution as the inflection point from the solution of the secondary differential signals, the solution being the value nearest to the first position information and the peak signal acquired by the first position information acquiring step.

4. A position detecting method according to claim 3, wherein the noise reducing step uses filter processing for the signal.

5. A position detecting method according to claim 3, wherein the noise reducing step uses function fitting for the signal.

6. A position detecting method according to claim 3, wherein the inflection point selecting step further selects a solution as the inflection point, the solution being the value nearest to design value of a center position in the alignment mark.

7. A position detecting method according to claim 1, wherein the first position information acquiring step uses a template matching method, and the second position information acquiring step uses an edge differentiating method.

8. A position detecting method according to claim 1, wherein the first position information acquiring step uses a geometrical pattern matching method, and the second position information acquiring step uses an edge differentiating method.

9. A position detecting method according to claim 1, wherein the first position information acquiring step uses a return-symmetrical processing method, and the second position information acquiring step uses an edge differentiating method.

10. A position detecting apparatus comprising of a processing means which executes a position detecting method according to claim 1.

11. A position detecting apparatus comprising of a processing means which executes a position detecting method according to claim 2.

12. An exposure apparatus comprising of a position detecting apparatus according to claim 10.

13. An exposure apparatus comprising of a position detecting apparatus according to claim 11.

14. A device fabricating method comprising the steps of:
exposing an object by an exposure apparatus according to one of claim 12; and
developing the exposed object.

15. A device fabricating method comprising the steps of:
exposing an object by an exposure apparatus according to one of claim 13; and
developing the exposed object.
